(19) United States
(12) Patent Application Publication
(10) Pub. No.: US 2023/0259753 A1
(43) Pub. Date: Aug. 17, 2023

(54) OPTICAL ARTIFICIAL NEURAL NETWORK SYSTEM

(71) Applicant: ELECTRONICS AND TELECOMMUNICATIONS RESEARCH INSTITUTE, Daejeon (KR)

(72) Inventors: Suntak PARK, Daejeon (KR); Jin Hwa GENE, Daejeon (KR); Bong Je PARK, Daejeon (KR); Seung Koo PARK, Daejeon (KR); Jong Moo SOHN, Daejeon (KR); Hyung Cheol SHIN, Daejeon (KR)

(73) Assignee: ELECTRONICS AND TELECOMMUNICATIONS RESEARCH INSTITUTE, Daejeon (KR)

(21) Appl. No.: 18/167,749

(22) Filed: Feb. 10, 2023

(30) Foreign Application Priority Data
Feb. 14, 2022 (KR) 10-2022-0019132
Jan. 25, 2023 (KR) 10-2023-0009561

(51) Int. Cl. G06N 3/067

(52) U.S. Cl. CPC G06N 3/0675

(57) ABSTRACT

Disclosed is an optical artificial neural network system which includes an optical hidden layer that receives an input light including input data and generates an output light by performing a linear process and a nonlinear process on the input data, and a light transfer unit that provides the output light to an input of the optical hidden layer, and the optical hidden layer performs the linear process and the nonlinear process based on the received output light.

### CROSS-REFERENCE TO RELATED APPLICATIONS

This application claims priority under 35 U.S.C. § 119 to Korean Patent Application Nos. 10-2022-0019132 filed on Feb. 14, 2022, and 10-2023-0009561 filed on Jan. 25, 2023, in the Korean Intellectual Property Office, the disclosures of which are incorporated by reference herein in their entireties.

### BACKGROUND

Embodiments of the present disclosure described herein relate to an artificial neural network, and more particularly, relate to an optical artificial neural network system.

An artificial neural network is a machine learning technique that processes information in a manner similar to the principle in which the human brain processes and learns information. With the development of computer hardware, the capability to process big data is improved, and a deep learning algorithm develops. This allows the artificial neural network technology to be rapidly expanded and applied to various fields such as voice recognition, pattern recognition, natural language processing, and medical data analysis.

The artificial neural network includes an input layer, a hidden layer, and an output layer, each of which is composed of nodes; the nodes process signal information like neurons. The nodes of the hidden layer add weights to signals received from the nodes of the input layer and perform nonlinear transformation on the addition results, and the outputs of the nodes of the hidden layer are transferred to the output layer such that a final output signal is generated.

The signal processing process of the artificial neural network is similar to that of a neuron, and the artificial neural network may include only one hidden layer or may include a plurality of hidden layers. An artificial neural network including a plurality of hidden layers is called a deep neural network (or a deep learning artificial neural network), and learning using the deep neural network is called deep learning.

The deep neural network using the deep learning requires a large amount of calculations for the purpose of optimizing a weight as the number of hidden layers increases. In particular, as the number of neurons and hidden layers increases, the amount of computation increases exponentially; in this case, calculation through a semiconductor-based electrical computer becomes more complex and requires greater power consumption, eventually reaching technical limitations.

To overcome the above limitations, optical neural computing technologies having an excellent characteristic in parallel processing have been proposed. The optical computing technologies may make it possible to process a vast amount of calculations at high speed with small power consumption, inherently as well as efficient parallel calculations.

### SUMMARY

Embodiments of the present disclosure provide an optical artificial neural network system capable of implementing a weight calculation, a nonlinear calculation, and an iteration of the calculations, which are required to process a deep learning algorithm.

Embodiments of the present disclosure provide an optical artificial neural network system implementing a deep neural network including a plurality of hidden layers.

According to an embodiment, an optical artificial neural network system includes an optical hidden layer that receives an input light including input data and generates an output light by performing a linear process and a nonlinear process on the input data, and a light transfer unit that provides the output light to an input of the optical hidden layer, and the optical hidden layer performs the linear process and the nonlinear process based on the received output light.

In an embodiment, the optical hidden layer includes an optical linear process unit that generates a processed light, which includes first processing data obtained by performing the linear process on the input data, based on the input light, a light focusing unit that collects the processed light, and an optical nonlinear process unit that generates the output light, which includes second processing data obtained by performing the nonlinear process on the first processing data, based on the processed light thus collected.

In an embodiment, the optical linear process unit includes a VMM system capable of performing a matrix calculation and a 4F system performing convolution.

In an embodiment, the optical nonlinear process unit includes a nonlinear optical material or an optical fiber having nonlinearity.

In an embodiment, the light transfer unit includes an optical fiber, a light distributing unit, and a coupler, the optical fiber provides the output light to the light distributing unit, wherein the light distributing unit distributes the output light received from the optical fiber, and the coupler provides the distributed output light to the optical hidden layer.

In an embodiment, the optical artificial neural network system further includes an output unit that provides a portion of the output light generated from the optical hidden layer to the light transfer unit and reflects and outputs the remaining portion thereof.

In an embodiment, the optical artificial neural network system further includes a light source that generates the input light.

According to an embodiment, an optical artificial neural network system includes an optical linear process unit that receives an input light and generates a first processed light by performing a linear process on input data, a wavelength converter that receives the first processed light and generates a second processed light having different wavelengths for respective pixel areas, an optical nonlinear process unit that receives the second processed light and generates an output light by performing a nonlinear process on the second processed light, and a light transfer unit that provides the output light to an input of the optical linear process unit.

In an embodiment, the wavelength converter further includes a smart pixel array, and the smart pixel array includes smart pixels respectively corresponding to the pixel areas.

In an embodiment, each of the smart pixels includes a first unit device and a second unit device connected in series, and each of the first and second unit devices includes an N-type semiconductor layer, an intrinsic semiconductor layer, and a P-type semiconductor layer sequentially formed.

In an embodiment, the light transfer unit includes an optical fiber, a light distributing unit, and a coupler, the optical fiber provides the output light to the light distributing unit, the light distributing unit distributes the output light received from the optical fiber for each wavelength, and the coupler provides the distributed output light to the optical hidden layer.

In an embodiment, the light distributing unit includes a diffractive grating.

In an embodiment, the optical linear process unit includes a VMM system capable of performing a matrix calculation and a 4F system performing convolution.

In an embodiment, the optical nonlinear process unit includes a nonlinear optical material or an optical fiber having nonlinearity.

According to an embodiment, an optical artificial neural network system includes an optical linear process unit that receives an input light including input data and generates a processed light including first processing data obtained by performing a linear process on the input data, a first time delay unit that generates a time-delayed processed light based on the processed light, an optical nonlinear process unit that outputs an output light by performing a nonlinear process on the first processing data based on the time-delayed processed light, and a light transfer unit that provides the output light to an input of the optical hidden layer.

In an embodiment, the light transfer unit includes an optical fiber, a light distributing unit, a second time delay unit, and a coupler, the optical fiber provides the output light to the light distributing unit, the light distributing unit distributes the output light received from the optical fiber, the second time delay unit time-delays the distributed output light, and the coupler provides the time-delayed output light to the optical hidden layer.

In an embodiment, the optical linear process unit includes a VMM system and a 4F system.

In an embodiment, the time delay unit includes an optical signal speed control device including a photonic crystal, a meta structure, or a meta material.

In an embodiment, the optical nonlinear process unit includes a nonlinear optical material or an optical fiber having nonlinearity.

### BRIEF DESCRIPTION OF THE FIGURES

The above and other objects and features of the present disclosure will become apparent by describing in detail embodiments thereof with reference to the accompanying drawings.

FIG. 1 is a diagram illustrating how an artificial neural network processes information.

FIG. 2 is a diagram illustrating how an artificial neural network processes information.

FIG. 3 is a diagram illustrating how an artificial neural network processes information.

FIG. 4 is a diagram illustrating an optical artificial neural network system according to an embodiment of the present disclosure.

FIG. 5 is a diagram illustrating an optical artificial neural network system according to an embodiment of the present disclosure.

FIG. 6 is a diagram illustrating a smart pixel array of FIG. 5.

FIG. 7 is a diagram illustrating a smart pixel of FIG. 6.

FIG. 8 is a diagram illustrating an optical artificial neural network system according to an embodiment of the present disclosure.

FIG. 9 is a graph illustrating a relationship between a time delay and a length of an optical fiber.

### DETAILED DESCRIPTION

As specific structural or functional descriptions for embodiments according to the concept of the invention disclosed herein are merely exemplified for purposes of describing the embodiments according to the concept of the invention, the embodiments according to the concept of the invention may be embodied in various forms but are not limited to the embodiments described herein.

While the embodiments according to the concept of the invention are susceptible to various modifications and alternative forms, specific embodiments thereof are shown by way of example in drawings and will herein be described in detail. It should be understood, however, that there is no intent to limit the invention to the particular forms disclosed, but on the contrary, the invention is to cover all modifications, equivalents, and alternatives falling within the spirit and scope of the invention.

It will be understood that, although the terms “first”, “second”, etc. may be used herein to describe various elements, these elements should not be limited by these terms. These terms are only used to distinguish one element from another.

The terminology used herein to describe embodiments of the invention is not intended to limit the scope of the invention. The articles “a,” “an,” and “the” are singular in that they have a single referent, however the use of the singular form in the present document should not preclude the presence of more than one referent. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

Below, embodiments of the present disclosure will be described in detail and clearly to such an extent that an ordinary one in the art easily implements the invention.

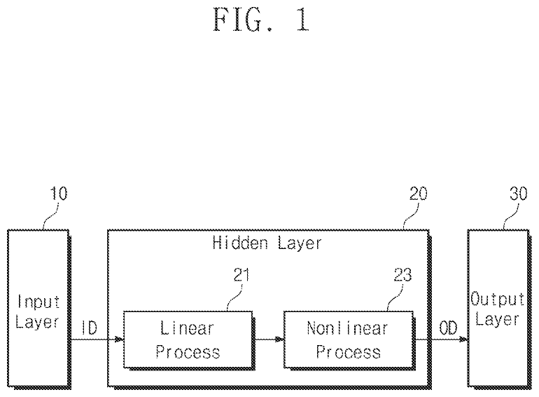

FIG. 1 is a diagram illustrating how an artificial neural network processes information.

Referring to FIG. 1, an artificial neural network may include an input layer 10, a hidden layer 20, and an output layer 30. Input data ID transferred from the input layer 10 may be processed by the hidden layer 20 such that output data OD are output to the output layer 30.

The input layer 10 may include a plurality of nodes. Each node may transfer the input data ID to the hidden layer 20.

The hidden layer 20 is configured to perform a linear process 21 and a nonlinear process 23 on the input data ID received from the input layer 10 such that the output data OD are provided to the output layer 30.

The output layer 30 may generate a prediction result based on the output data OD received from the hidden layer 20.

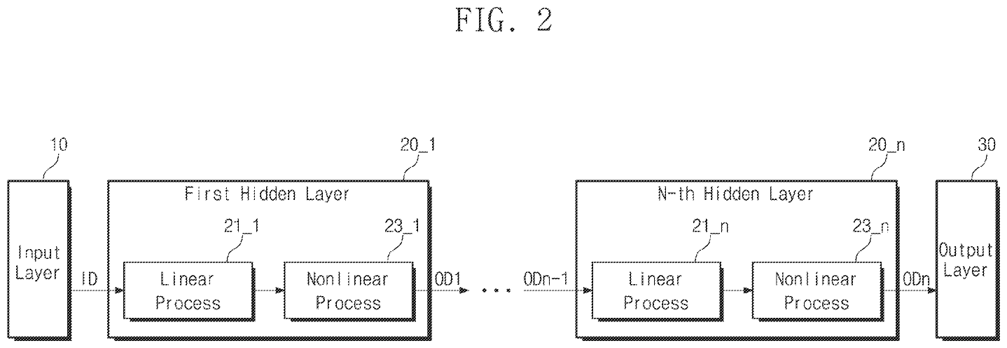

FIG. 2 is a diagram illustrating how an artificial neural network processes information.

Referring to FIG. 2, the artificial neural network may include the input layer 10, a plurality of hidden layers 20_1 to 20_n, and the output layer 30. The hidden layers 20_1 to 20_n may be sequentially connected. Each of the hidden layers 20_1 to 20_n may perform a linear process (e.g., 21_1, . . . , 21_n-1, or 21_n) and a nonlinear process (e.g., 23_1, . . . , 23_n-1, or 23_n) based on output data OD1 of the previous hidden layer. For example, the artificial neural network may be a deep neural network.

As the number of hidden layers 20_1 to 20_n increases, the accuracy of prediction of the artificial neural network may become higher.

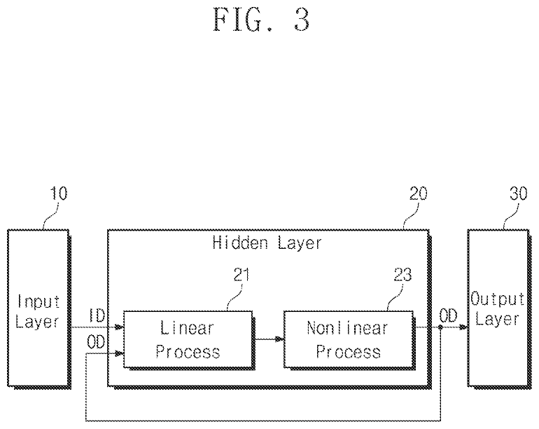

FIG. 3 is a diagram illustrating how an artificial neural network processes information.

Referring to FIG. 3, the output of the hidden layer 20 may be fed back to the input of the hidden layer 20. In this case, the linear process and the nonlinear process may be iteratively performed by using one hidden layer 20. The final output data may be obtained after the processes of the hidden layer 20 are iteratively performed as much as the desired number of hidden layers 20.

In the case of the deep neural network, as the number of hidden layers increases, the accuracy of prediction may be improved; however, in the case of implementing the deep neural network in an electrical signal-based computing device, the amount of calculation in the computing device increases rapidly, thereby causing an increase in a time and a power required for calculation.

A way to optically implement the deep neural network has been researched to overcome the above issue of the deep neural network, but conventional optical approach methods have limitations in performance and volume in terms of calculation methods. Also, even in implementing a plurality of hidden layers, an accurate structure for optically implementing all iterative calculation processes has not been presented. To overcome the above issues, an optical artificial neural network system according to embodiments of the present disclosure will be described in detail.

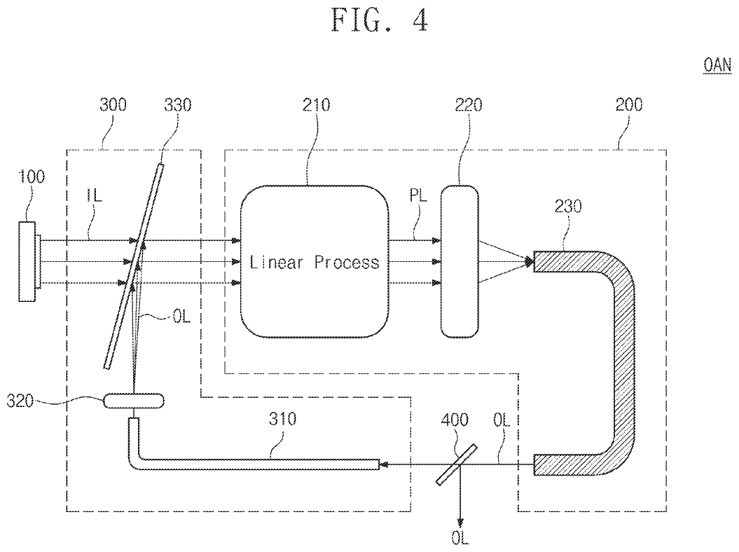

FIG. 4 is a diagram illustrating an optical artificial neural network system according to an embodiment of the present disclosure. Referring to FIG. 4, an optical artificial neural network system OAN may include a light source 100, an optical hidden layer 200, a light transfer unit 300, and an output unit 400. In an embodiment, a portion of an output light OL output from the optical hidden layer 200 may again be input to the optical hidden layer 200 through the light transfer unit 300. As such, an embodiment according to the present disclosure may obtain the same effect as a plurality of hidden layers are implemented, by using the single optical hidden layer 200.

The light source 100 may be configured to generate an input light IL generating light signals. The input light IL generated by the light source 100 may include input data. The input light IL may be in the shape of a planar light. Pixel areas corresponding to nodes may be defined in the input light IL that is in the shape of a planar light. Each pixel area may include input data corresponding thereto. For example, the pixel area may store the input data by adjusting the intensities of light signals included in an incident light.

The input light IL may be irradiated to the optical hidden layer 200. In an embodiment, the input light IL may be irradiated to the optical hidden layer 200 through a coupler 330 to be described later. However, the present disclosure is not limited thereto. For example, the input light IL may be provided to the optical hidden layer 200 without passing through the coupler 330.

The optical hidden layer 200 may be configured to perform a linear process and a nonlinear process based on the received input light IL. The optical hidden layer 200 may be configured to generate the output light OL including output data obtained by performing the linear process and the nonlinear process on the input data. The optical hidden layer 200 may perform the linear process and the nonlinear process by using a light signal. The optical hidden layer 200 may play a role of the hidden layer 20 of the artificial neural network in FIGS. 1 to 3.

The optical hidden layer 200 may include an optical linear process unit 210, a light focusing unit 220, and an optical nonlinear process unit 230. In an embodiment, the optical linear process unit 210, the light focusing unit 220, and the optical nonlinear process unit 230 may be disposed in series.

The optical linear process unit 210 may be configured to receive the input light IL from the light source 100. The optical linear process unit 210 may be configured to generate a processed light PL including first processing data being a result of performing a linear process on input data based on the received input light IL.

The optical linear process unit 210 may be configured to perform the linear process on the input data. The linear process may include, for example, assigning a weight or a bias to input data and performing matrix calculation, convolution calculation, etc. For example, the linear process may be performed for each of the pixel areas of the input light IL corresponding to the nodes.

The optical linear process unit 210 may include an optical device configured to perform the linear process. For example, the optical linear process unit 210 may include opto-electric devices, such as a light modulator which include a plurality of pixels, or a lens and opto-electric systems, which are implemented by a combination of the opto-electric devices, such as a vector matrix multiplication (VMM) system and a 4F system.

The light modulator may include a plurality of pixels corresponding to a plurality of nodes. In each of the pixel areas, the intensity, phase, and/or polarization state of a light may change due to the plurality of pixels. The lens may transform the input data (e.g., may perform Fourier transform on the input data).

The VMM system may be configured to assign a weight or a bias to the input data and perform matrix calculation. The 4F system may be configured to perform convolution calculation on the input data. However, the present disclosure is not limited thereto. For example, the optical linear process unit 210 may further include an optical device or an optical system for performing various linear processes.

However, the present disclosure is not limited thereto. For example, each opto-electric device may receive a user input signal, and a weight, a bias, or a linear calculation equation may change based on the user input signal. The user input signal may be an electrical signal. In an embodiment, the linear or nonlinear calculation equation may be differently set by controlling the user input signal every period where the linear process and the nonlinear process are performed by the optical hidden layer 200.

The processed light PL generated by the optical linear process unit 210 may be provided to the light focusing unit 220.

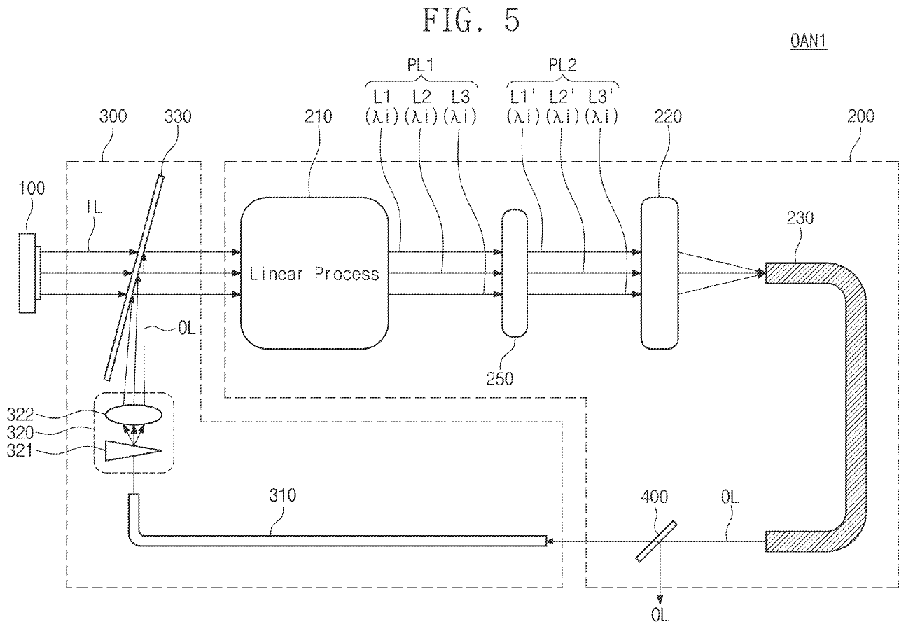

The light focusing unit 220 may be configured to receive the processed light PL. The light focusing unit 220 may be configured to collect the processed light PL at one point. A processed light collected by the light focusing unit 220 may be provided to the optical nonlinear process unit 230. Examples of the light focusing unit 220 will be described in detail with reference to FIGS. 5 to 9.

The optical nonlinear process unit 230 may be configured to receive the collected processed light PL. The optical nonlinear process unit 230 may be configured to generate the output light OL including second processing data being a result of performing a nonlinear process on the first processing data based on the collected processed light PL.

The optical nonlinear process unit 230 may be configured to perform the nonlinear process on the first processing data. The nonlinear process may include, for example, an activation function, a step function, an ReLU, etc. For example, the nonlinear process may be performed identically at all the nodes of the collected processed light PL.

The optical nonlinear process unit 230 may include an optical device configured to perform the nonlinear process. For example, the optical device may include a nonlinear optical material, an optical fiber having nonlinearity, or an optical fiber type nonlinear device capable of performing the nonlinear process.

The optical fiber having nonlinearity may include a chalcogenide material. The optical fiber having nonlinearity may perform the nonlinear process by using a nonlinear polarization characteristic of the optical fiber. The nonlinear device may include a saturable absorber material. The nonlinear device may be formed such that a material having a nonlinear characteristic is adjacent to a core of the optical fiber. As such, the nonlinear device may allow a light passing through the optical fiber core to have nonlinearity.

The output light OL generated by the optical nonlinear process unit 230 may be provided to the output unit 400.

The output unit 400 may be configured to transmit a portion of the output light OL and to reflect the remaining portion thereof. For example, the output unit 400 may include a beam splitter configured to transmit a portion of the output light OL and to reflect the remaining portion thereof. The output light OL passing through the output unit 400 may be provided to the light transfer unit 300. The light reflected by the output unit 400 may be output as the output light OL. However, the present disclosure is not limited thereto. The light reflected by the output unit 400 may be provided to the light transfer unit 300; in this case, there may be output a light to the outside.

The light transfer unit 300 may be configured to receive the output light OL from the output unit 400. The light transfer unit 300 may be configured to again provide the output light OL to the input of the optical hidden layer 200. As such, the linear process and the nonlinear process for the output light OL may be iteratively performed.

The light transfer unit 300 may include an optical fiber 310, a light distributing unit 320, and the coupler 330.

The optical fiber 310 may be configured to receive the output light OL from the output unit 400. The light transfer unit 300 may be configured to provide the received output light OL to the light distributing unit 320. For example, the light transfer unit 300 may output the received output light OL without modification. As another example, the light transfer unit 300 may be configured to amplify the output light OL such that the intensity of light is adjusted. As another example, the light transfer unit 300 may be configured to change the polarization or phase of the output light OL.

A time delay may occur between the output light OL input to the light transfer unit 300 and the output light OL output to the light distributing unit 320 depending on the length of the optical fiber 310. In an embodiment, an iterative period of the linear process and the nonlinear process may be adjusted by adjusting the length of the optical fiber 310. In an embodiment, while the time to output the output light OL is delayed by the optical fiber 310, the weight and linear calculation equation may be modified by controlling the user input signal input to the opto-electric devices of the optical hidden layer 200.

The light distributing unit 320 may be configured to distribute the output light OL from the optical fiber 310. The output light OL distributed by the light distributing unit 320 may be provided to the coupler 330. Examples of the light distributing unit 320 will be described in detail with reference to FIGS. 5 to 9.

The coupler 330 may be configured to provide the output light OL distributed by the light distributing unit 320 to the optical hidden layer 200. In an embodiment, the coupler 330 may be configured to reflect the output light OL distributed by the light distributing unit 320 so as to be provided to the optical hidden layer 200. The linear process and the nonlinear process may be performed as the light reflected by the coupler 330 passes through the optical linear process unit 210, the light focusing unit 220, and the optical nonlinear process unit 230 of the optical hidden layer 200. As such, the linear process and the nonlinear process for the second processing data may be again performed. When the light passes through the optical hidden layer 200 and the light transfer unit 300 iteratively “n” times, the linear process and the nonlinear process may be performed “n” times.

The output light OL output from the output unit 400 may include the final output data obtained by iteratively performing the linear and nonlinear processes of the optical hidden layer 200 on the input data.

In an embodiment, in the optical artificial neural network system OAN of the present disclosure, both the linear and nonlinear processes of the input data and the transfer of the output data to the input data may be optically performed by using a light signal.

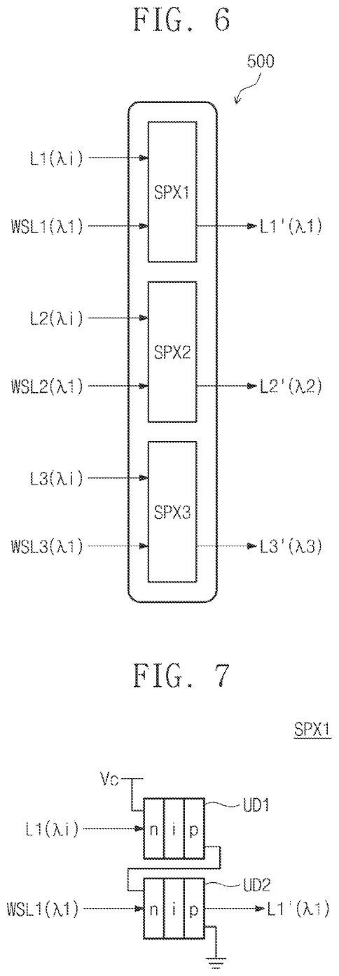

FIG. 5 is a diagram illustrating an optical artificial neural network system according to an embodiment of the present disclosure. FIG. 6 is a diagram illustrating a smart pixel array of FIG. 5. FIG. 7 is a diagram illustrating a smart pixel of FIG. 6. Below, an embodiment of an optical artificial neural network system will be described in detail based on a difference with the embodiment described with reference to FIG. 4.

Referring to FIG. 5, an optical artificial neural network system OAN1 of a wavelength division scheme may be provided. In an embodiment, the optical artificial neural network system OAN of FIG. 4 may further include a wavelength converter 250. The light source 100, the optical hidden layer 200, and the output unit 400 may be substantially identical to those of FIG. 4.

Pixel areas corresponding to nodes may be defined in a first processed light PL1 passing through the optical linear process unit 210 to which the input light IL is input. Each pixel area may include data corresponding thereto. In an embodiment, in the pixel areas, the first processed light PL1 may have the same wavelengths or may be in a state where different wavelengths overlap each other.

The wavelength converter 250 may be configured to receive the first processed light PL1 and to generate a second processed light PL2 having different wavelengths for respective pixel areas (e.g., nodes). That is, each node has the same wavelength or an overlapping wavelength from the input light IL to the first processed light PL1; however, after passing through the wavelength converter 250, the nodes have different wavelengths. For example, the wavelength converter 250 may include a smart pixel array. Although not illustrated in drawing, a coupler or a wavelength selecting and reflecting filter may be included between the optical linear process unit 210 and the wavelength converter 250. Below, the wavelength converter 250 will be described in detail with reference to FIGS. 6 and 7.

Referring to FIG. 6, the wavelength converter 250 may include a plurality of smart pixels SPX1 to SPX3. The smart pixels SPX1 to SPX3 may respectively correspond to the pixel areas of the first processed light PL1. For example, the wavelength converter 250 may include the first smart pixel SPX1 receiving a first input light L1 of a first pixel area, the second smart pixel SPX2 receiving a second input light L2 of a second pixel area, and the third smart pixel SPX3 receiving a third input light L3 of a third pixel area. The first to third smart pixels SPX1 to SPX3 may be substantially identical, and below, the description will be given with reference to the first smart pixel SPX1.

Referring to FIG. 7, the first smart pixel SPX1 may be configured to receive a first wavelength light WSL1 and the input light L1 of the first pixel area and to generate a first wavelength-converted input light L1′. The first wavelength light WSL1 may be a light of a specific wavelength (e.g., a first wavelength λ1). Unlike the input light L1, the first wavelength-converted input light L1′ may have the first wavelength λ1. In other words, a smart pixel may be configured to generate a wavelength-converted input light having the same wavelength as a received wavelength light.

The first smart pixel SPX1 may include a first unit device UD1 and a second unit device UD2 connected in series. Each of the first unit device UD1 and the second unit device UD2 may include an N-type semiconductor layer, an intrinsic semiconductor layer, and a P-type semiconductor layer.

An active voltage Vc may be applied to the N-type semiconductor layer of the first unit device UD1, and the P-type semiconductor layer of the first unit device UD1 may be electrically connected with the N-type semiconductor layer of the second unit device UD2. A ground voltage may be applied to the P-type semiconductor layer of the second unit device UD2.

The first unit device UD1 may receive the input light L1 of the first pixel area. In this case, a voltage or a current that is applied to the second unit device UD2 may change depending on the intensity of the input light L1 of the first pixel area.

The second unit device UD2 may be configured to receive the first wavelength light WSL1 and to generate the first wavelength-converted input light L1′. As the voltage applied to the second unit device UD2 changes, the transmittance and reflectance of the second unit device UD2 for the first wavelength light WSL1 may change. In other words, the second unit device UD2 may be configured to transmit a portion of the first wavelength light WSL1 to generate the first wavelength-converted input light L1′.

The first wavelength-converted input light L1′ may include input data of the input light L1 of the first pixel area. Likewise, a second wavelength-converted input light L2′ may receive input data of the input light L2 of the second pixel area, and a third wavelength-converted input light L3′ may receive input data of the input light L3 of the third pixel area.

However, the number of smart pixels included in the wavelength converter 250 is not limited to 3, and smart pixels may be further included. For example, the number of smart pixels may be equal to the number of nodes.

Returning to FIG. 5, the second processed light PL2 generated by the wavelength converter 250 may be provided to the light focusing unit 220.

Like the description given with reference to FIG. 4, the light focusing unit 220 may be configured to collect the second processed light PL2 so as to be provided to the optical nonlinear process unit 230. The optical nonlinear process unit 230 may be configured to generate the output light OL by performing the nonlinear process on the second processed light PL2.

The light transfer unit 300 may be configured to receive the output light OL from the output unit 400 and to provide the output light OL to the optical hidden layer 200.

In an embodiment, the light distributing unit 320 of the light transfer unit 300 may include an optical splitter 321 and a lens 322. The optical splitter 321 may include, for example, a diffractive grating, a prism, etc. In an embodiment, the optical splitter 321 may be configured to split the output light OL for each wavelength. The output light OL split by the optical splitter 321 may be provided to the coupler 330.

The coupler 330 may be configured to receive the output light OL split for each wavelength and to provide the output light OL to the optical hidden layer 200. In an embodiment, the light collected by the light focusing unit 220 may be spatially split for each wavelength so as to be provided to the optical hidden layer 200.

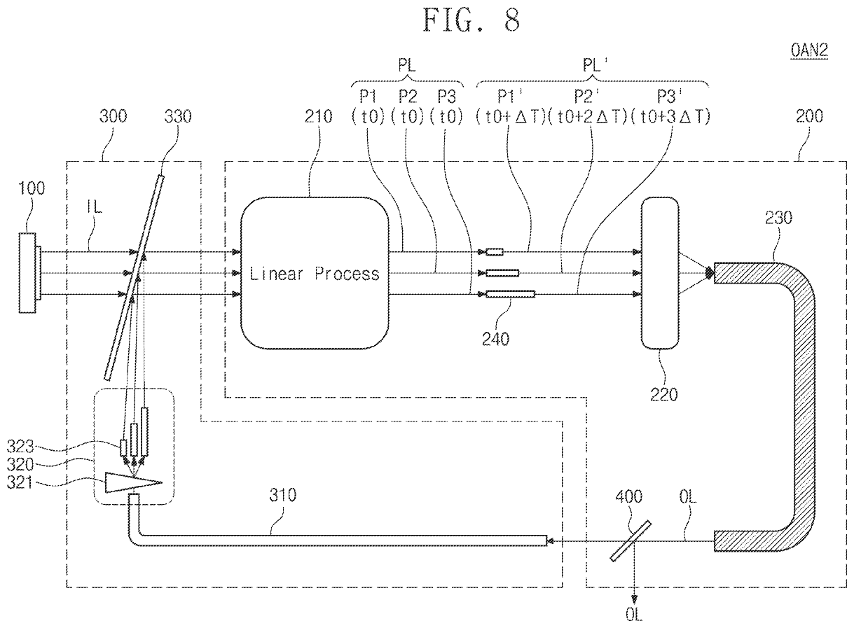

FIG. 8 is a diagram illustrating an optical artificial neural network system according to an embodiment of the present disclosure. Below, an embodiment of an optical artificial neural network system will be described in detail based on a difference with the embodiment described with reference to FIGS. 4 and 5.

Referring to FIG. 8, an optical artificial neural network system OAN2 of a time division scheme may be provided. In an embodiment, a first time delay unit 240 and a second time delay unit 323 may be further included in the optical artificial neural network system OAN of FIG. 4. The light source 100 and the output unit 400 may be substantially identical to those of FIG. 4.

The optical linear process unit 210 of the optical hidden layer 200 may be configured to generate the processed light PL by performing the linear process based on the received input light IL. Pixel areas including the first processing data may be defined in the processed light PL. Each pixel area may include the first processing data corresponding thereto. In an embodiment, in each pixel area, the processed light PL may be in a state where there is no time delay.

The first time delay unit 240 may be provided between the optical linear process unit 210 and the light focusing unit 220. The first time delay unit 240 may be configured to receive the processed light PL from the optical linear process unit 210. The first time delay unit 240 may be configured to generate a time-delayed processed light PL′ based on the received processed light PL.

The first time delay unit 240 may include a plurality of fibers. The fibers may respectively correspond to the pixel areas of the processed light PL. For example, the first time delay unit 240 may include first to third fibers respectively corresponding to the first to third pixel areas.

For example, the first fiber may be configured to generate a first time-delayed processed light P1′ by delaying the processing light P1 of the first pixel area as much as a first time ΔT; the second fiber may be configured to generate a second time-delayed processed light P2′ by delaying the processing light P2 of the second pixel area as much as a second time 2ΔT; the third fiber may be configured to generate a third time-delayed processed light P3′ by delaying the processing light P3 of the third pixel area as much as a third time 3ΔT.

A time taken for the time-delayed processed light PL′ to reach the light focusing unit 220 may differ for each pixel area. For example, the first time ΔT may be smaller than the second time 2ΔT, and the second time 2ΔT may be lower than the third time 3ΔT. In this case, the first time-delayed processed light P1′ of the first pixel area may first reach the light focusing unit 220, the second time-delayed processed light P2′ of the second pixel area may then reach the light focusing unit 220, and the third time-delayed processed light P3′ of the third pixel area may finally reach the light focusing unit 220.

The light distributing unit 320 of the light transfer unit 300 may include the second time delay unit 323. The light distributing unit 320 may be configured to distribute the output light OL received from the optical fiber 310 so as to be provided to the second time delay unit 323.

The optical splitter 321 may be configured to split lights in the order of receiving lights from the optical fiber 310. For example, the time-delayed processed lights P1′, P2′, and P3′ that sequentially reach the light focusing unit 220 after generated by the first time delay unit 240 may sequentially reach the optical splitter 321 through the optical nonlinear process unit 230, the output unit 400, the optical fiber 310.

The output light OL split by the optical splitter 321 may be provided to the second time delay unit 323.

The second time delay unit 323 may include a plurality of fibers. The fibers of the second time delay unit 323 may respectively correspond to the fibers of the first time delay unit 240. For example, the second time delay unit 323 may include a fourth fiber corresponding to the first fiber, a fifth fiber corresponding to the second fiber, and a sixth fiber corresponding to the third fiber.

The fourth to sixth fibers may be configured to delay the time to output the output light OL received (or to time-delay the output light OL received). For example, the fourth fiber may be configured to delay the received output light OL as much as the third time 3ΔT, the fifth fiber may be configured to delay the received output light OL as much as the second time 2ΔT, and the sixth fiber may be configured to delay the received output light OL as much as the first time ΔT. As such, the output light OL may be provided to the coupler 330 for each pixel area, in a state where there is no time delay.

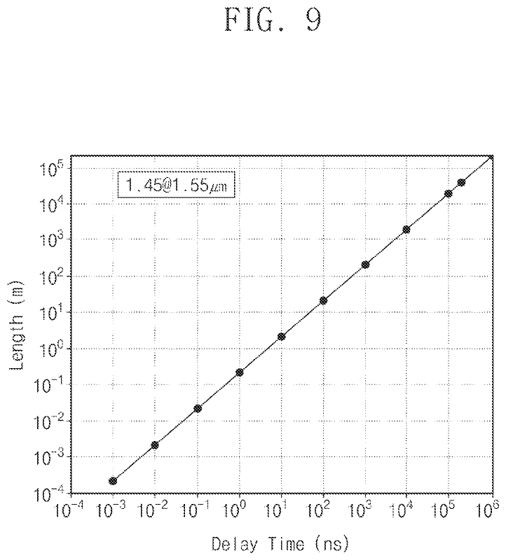

FIG. 9 is a graph illustrating a relationship between a time delay and a length of an optical fiber.

FIG. 9 shows a result of calculating the time delay depending on the length of the optical fiber, and the refractive index of the optical fiber used in calculation is 1.45 (@1.55 μm). A time delay “t” according to the length of the optical fiber is expressed by Equation 1 below.

$$t = \frac{nL}{c} \qquad [ Equation 1 ]$$

In Equation 1, “n” is an effective refractive index of the optical fiber, “L” is a length of the optical fiber, and “c” is the speed of light. For example, for a time delay of 1 ns, an optical fiber length of 0.207 m is required.

Each of the first and second time delay units 240 and 323 may be implemented with an element or a material, which is capable of making transfer speeds of optical signals different for respective nodes, such as a photonic crystal or a meta material, in addition to the optical fiber.

According to an embodiment of the present disclosure, there is provided an optical artificial neural network system capable of implementing a weight calculation, a nonlinear calculation, and an iteration of the calculations, which are required to process learning algorithm.

According to an embodiment of the present disclosure, an optical artificial neural network system implementing a deep neural network including a plurality of hidden layers is provided.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. An optical artificial neural network system comprising:
an optical hidden layer configured to receive an input light including input data and to generate an output light by performing a linear process and a nonlinear process on the input data; and
a light transfer unit configured to provide the output light to an input of the optical hidden layer,
wherein the optical hidden layer is configured to perform the linear process and the nonlinear process based on the received output light.

2. The optical artificial neural network system of claim 1, wherein the optical hidden layer includes:
an optical linear process unit configured to generate a processed light, which includes first processing data obtained by performing the linear process on the input data, based on the input light;
a light focusing unit configured to collect the processed light; and
an optical nonlinear process unit configured to generate the output light, which includes second processing data obtained by performing the nonlinear process on the first processing data, based on the processed light thus collected.

3. The optical artificial neural network system of claim 2, wherein the optical linear process unit includes a VMM system capable of performing a matrix calculation and a 4F system performing convolution.

4. The optical artificial neural network system of claim 2, wherein the optical nonlinear process unit includes a nonlinear optical material or an optical fiber having nonlinearity.

5. The optical artificial neural network system of claim 1, wherein the light transfer unit includes an optical fiber, a light distributing unit, and a coupler,
wherein the optical fiber is configured to provide the output light to the light distributing unit,
wherein the light distributing unit is configured to distribute the output light received from the optical fiber, and
wherein the coupler is configured to provide the distributed output light to the optical hidden layer.

6. The optical artificial neural network system of claim 1, further comprising:
an output unit configured to provide a portion of the output light generated from the optical hidden layer to the light transfer unit and to reflect and output the remaining portion thereof

7. The optical artificial neural network system of claim 1, further comprising:
a light source configured to generate the input light.

8. An optical artificial neural network system comprising:
an optical linear process unit configured to receive an input light and to generate a first processed light by performing a linear process on input data;
a wavelength converter configured to receive the first processed light and to generate a second processed light having different wavelengths for respective pixel areas;
an optical nonlinear process unit configured to receive the second processed light and to generate an output light by performing a nonlinear process on the second processed light; and
a light transfer unit configured to provide the output light to an input of the optical linear process unit.

9. The optical artificial neural network system of claim 8, wherein the wavelength converter further includes a smart pixel array, and
wherein the smart pixel array includes smart pixels respectively corresponding to the pixel areas.

10. The optical artificial neural network system of claim 9, wherein each of the smart pixels includes a first unit device and a second unit device connected in series, and
wherein each of the first and second unit devices includes an N-type semiconductor layer, an intrinsic semiconductor layer, and a P-type semiconductor layer sequentially formed.

11. The optical artificial neural network system of claim 8, wherein the light transfer unit includes an optical fiber, a light distributing unit, and a coupler,
wherein the optical fiber is configured to provide the output light to the light distributing unit,
wherein the light distributing unit is configured to distribute the output light received from the optical fiber for each wavelength, and
wherein the coupler is configured to provide the distributed output light to the optical hidden layer.

12. The optical artificial neural network system of claim 11, wherein the light distributing unit includes a diffractive grating.

13. The optical artificial neural network system of claim 8, wherein the optical linear process unit includes a VMM system capable of performing a matrix calculation and a 4F system performing convolution.

14. The optical artificial neural network system of claim 8, wherein the optical nonlinear process unit includes a nonlinear optical material or an optical fiber having nonlinearity.

15. An optical artificial neural network system comprising:
an optical linear process unit configured to receive an input light including input data and to generate a processed light including first processing data obtained by performing a linear process on the input data;
a first time delay unit configured to generate a time-delayed processed light based on the processed light;
an optical nonlinear process unit configured to output an output light by performing a nonlinear process on the first processing data based on the time-delayed processed light; and
a light transfer unit configured to provide the output light to an input of the optical linear process unit.

16. The optical artificial neural network system of claim 15, wherein the light transfer unit includes an optical fiber, a light distributing unit, a second time delay unit, and a coupler,
wherein the optical fiber is configured to provide the output light to the light distributing unit,
wherein the light distributing unit is configured to distribute the output light received from the optical fiber,
wherein the second time delay unit is configured to time-delay the distributed output light, and
wherein the coupler is configured to provide the time-delayed output light to the optical hidden layer.

17. The optical artificial neural network system of claim 15, wherein the optical linear process unit includes a VMM system and a 4F system.

18. The optical artificial neural network system of claim 16, wherein the time delay unit includes an optical signal speed control device including a photonic crystal, a meta structure, or a meta material.

19. The optical artificial neural network system of claim 16, wherein the optical nonlinear process unit includes a nonlinear optical material or an optical fiber having nonlinearity.
